(19) United States
(12) Patent Application Publication
(10) Pub. No.: US 2008/0319923 A1
(43) Pub. Date: Dec. 25, 2008

(54) Investment Analysis and Planning System and Method

(75) Inventors: Audrey Lynn Casey, Burnaby (CA); David Edwards, Burnaby (CA)

Correspondence Address: GOWLING LAFLEUR HENDERSON LLP (OTT), SUITE 2600, 160 ELGIN STREET, OTTAWA, ON, K1P1C3, CA

(73) Assignee: Copperleaf Technologies Inc, Burnaby (CA)

(21) Appl. No.: 12/141,567

(22) Filed: Jun. 18, 2008

Related U.S. Application Data
(63) Continuation of application No. 11/967,672, filed on Dec. 31, 2007.
(60) Provisional application No. 60/945,551, filed on Jun. 21, 2007.

(51) Int. Cl. G06Q 40/00

(52) U.S. Cl. 705/36 R; 705/35

(57) ABSTRACT

A system for modeling and comparing supply of and demand for output of productive assets in an asset based business, the system including a database having one or more demand data structures each comprising a device field for storing data representing a device which consumes said output of the productive assets; and an expenditure data structure associated with each device for storing one or more attribute values corresponding to cost and benefits of the device over time.

### CROSS-REFERENCE TO RELATED APPLICATIONS

This application claims priority from (United States) U.S. Provisional application No. 60/945,551 filed Jun. 21, 2007 and is a continuation in part of U.S. application Ser. No. 11/967,672 filed Dec. 31, 2007 which also claims priority from U.S. Provisional application No. 60/945,551 filed Jun. 21, 2007, the disclosures of which are incorporated herein by reference in their entirety.

### FIELD OF THE INVENTION

The present invention relates generally to planning systems and methods and, particularly to a system and method for planning asset investment decisions utilising computer implemented models of business scenarios in an asset based business.

### BACKGROUND OF THE INVENTION

Many asset-based businesses, such as electricity generation facilities, are beginning to face problems with their asset-based infrastructure in that, as their equipment has a defined life, they must plan for when their equipment reaches the end of their design life. Reliability is becoming an increasing concern. Decisions to repair or to replace are being made, not just on specific equipment items, but on entire facilities. Environmental, safety, and social concerns relating to the overall business also introduce new costs, business objectives and constraints, and reporting requirements. For example shareholders, regulators, customers and Boards increasingly want transparent yet rigorous and methodical processes that demonstrate the prudent and careful management of a businesses portfolio of assets. At the same time, long-term sustainability has become a key issue for many executives in asset-intensive businesses. As the focus shifts to sustaining their portfolio of assets, business requires new processes and tools to support strategic asset planning, and to integrate these with budgeting and performance management.

While it is commonly understood that a businesses asset base encompasses physical equipment items, in the present description we define an asset base more broadly to also encompass all definable elements associated with a business that can bring value over time to the business (i.e. productive assets) such as intellectual property portfolios, customer base, brand, etc.

Current tools for asset planning are based on models of equipment items which predict the ROI (return on investment) or productive capacity (as a single output of the model) for that equipment item. This type of equipment item model is limited to modeling the impact of that component equipment item on the overall performance of the asset in which it is contained. This approach does not provide for modelling the long term economic viability of the containing asset and therefore can lead to stranded investments at the component level. For example, a decision to replace a custom assembly machine in a canning plant should consider not only the impact of the assembly machine on the plant's operation but also the market value and life of the plant and the product that that plant produces. Failure to do so could result in a locally optimal decision to replace the assembly machine when an expected drop in the market value of the output of the overall plant may render the plant, and thereby any investment in improving it, non-economic. Such investment if it were to be made in a plant which becomes non-economic would be considered a “stranded investment”.

Other tools used historically measured event probabilities to predict the performance and status of the physical assets into the future. Such tools, while useful in predicting a system's future operation and reliability, are of limited use in the current asset investment application as they generally address only the supply or cost side of a business, they may not consider the impact of incremental investment on attributes of the asset beyond the probability of component failure, such as maintenance cost, consumables usage, etc., and they are limited to applications where the component reliability information is readily available and dependable.

Another short-coming of the currently employed planning systems relates to the limited timeframe over which investments are made. Typical planning systems focus and support capital investment budget cycles of one to three years and therefore seek to identify maximum economic impact of a select portfolio of investment alternatives within this time horizon. This is problematic for capital asset intensive businesses where asset life and productive value should be considered over decades.

A further limitation of current planning tools is that they assume a fixed market value for a product or service and do not consider such factors as changing market demand for a product or service, the change in market value of the productive output of an asset, or impact of activities and investments designed to increase, decrease or in some other manner modify the demand for the businesses products and services.

Accordingly a need in an asset-based business is for a system and method which mitigates the above disadvantages and provides a flexible, enterprise-wide planning tool for modeling and analyzing investment alternatives which revolve around a company's asset base, while simultaneously considering these investment alternatives within a dynamic and responsive market environment.

Another need in an asset based business is an ability to plan for investment in an asset base where price and demand for the businesses products and services will vary and wherein investments in the asset base or directly in the market will impact the price and demand for the business' products and services.

A still further need is to provide a flexible, responsive reporting system for use in analyzing the investments and business model described by way of a data structure which may be organized into a hierarchy of productive assets and their comprised equipment item components.

### SUMMARY OF THE INVENTION

An advantage of the present invention is to provide a computer-based system and method for creating, using and testing models of a plurality of investment and market scenarios in an asset based business, in which the scenarios consider: investment in the assets of the company based on different market demands for products and services produced by the assets; consumer behaviour modification for the goods and services produced by the assets; and the effects over time of the investment on costs and impacts of those assets.

A further advantage of the invention is to provide a computer-based system and method that makes use of the computer based models to allow a user to select, display and compare different asset investment scenarios.

In a further embodiment of the current invention there is provided a system of modules, libraries and databases utilizing the component data structure which allows for modeling the assets of a business and evaluating and reporting investment alternatives in those assets wherein the market environment for the productive output of those assets may change over time either dependently or independently of the investment alternatives.

In accordance with the present invention there is provided a method for comparing investments in productive assets with investments in modifying demand for output of the productive assets, in an asset based business, the method comprising the steps of:

inputting objectives or constraints of the business;

retrieving data from one or more asset data structures each for storing data representing assets of the business, the assets having an ascertainable productive output with forecastable market value and having an associated attribute data structure for storing one or more attribute value corresponding to the financial and non-financial productive outputs, inputs, and associated impacts of an asset over a time period which relates to the useful productive life of the asset;

processing said retrieved data to generate a current and projected productive output set for a current asset investment comprising aggregated impact and costs attributes over time of selected assets;

retrieving consumer data from a demand data structure representing modified consumer demand corresponding to a requested demand side management program;

processing said retrieved consumer data to generate a modified consumer demand comprising aggregated impact and costs attributes over time of the requested demand side management program;

comparing all consolidated attributes of the asset investment, demand side management program, projected demand, current and projected productive output, and objectives and constraints of the business; and

identifying conflicts between the current asset investment, the requested demand side management program, and the objectives or constraints of the business.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 is a block diagram of an asset planning system according to an embodiment of the invention;

FIG. 2 is a schematic diagram showing how the investment alternatives relate to an asset hierarchy in an asset base model according to an embodiment of the present invention;

FIG. 3 is a screen display showing attributes and values in an investment alternative for a predetermined expenditure according to an embodiment of the invention;

FIG. 4 is an entity relationship diagram for the asset model according to an embodiment of the invention;

FIG. 5 is a schematic diagram showing Demand Side Management (DSM) functional logic according to an embodiment of the present invention;

FIG. 6 is an entity relationship diagram for a demand model according to an embodiment of the invention;

FIG. 7 is a. is a screen display showing attributes and values for a DSM program according to an embodiment of the invention;

FIG. 8 is a schematic diagram showing a device pair relationship for a DSM package; and

FIG. 9 is a flow diagram showing the use of the planning system for comparing DSM and asset base investments.

### DETAILED DESCRIPTION OF PREFERRED EMBODIMENTS

In the following description like numerals refer to like structures in the drawings.

An asset-based business exists to support demand for a product or service from potential customers. In conventional and accepted business terminology, the demand side of a business relates to the environment external to the operations of a business and includes processes, decisions and operations associated with generating customer demand for the output of a business. It includes the market within which a business operates and provides its products and the changes that the business can impart on its market through its decisions and investments including but not limited to, changes in product pricing, product offering and sales channels. The internal side of a business is conventionally referred to as the supply side of a business and relates to the processes, decisions and operations associated with fulfilling customer demand for the output of a business. It includes the supply chain management, asset base and supporting operations which allows a business to provide its products and the changes that the business can have on its own internal operations and supply chain management through its decisions and investments including but not limited to, changes in asset capability and operation.

Planning encompasses three activities, namely modeling, analyzing, and approving.

Modeling refers to a process for constructing a data structure that represents how different business scenarios (such as asset replacement, customer demand etc) can be quantified and monetized in a varying and uncertain environment. A model of a particular business scenario allows capture of appropriate data to support decisions about assets made both within the organizations shorter term budget cycle and over the full term of an asset's life.

Analyzing refers to the application of the model to determine answers to “what-if” scenarios and conducting analyses on the impact of various scenarios are expected to have on the performance of the organization relative to its business objectives.

Approving refers to a process for recommending a decision to the organization based on the reports generated during the analyzing phase and by reviewing the results of the decision against alternative decisions and the objectives and constraints of the business.

In addition, asset investment planning systems must increasingly support the “Triple Bottom Line” approach to modeling, analyzing and approving investment scenarios by considering scenario costs and benefits against three factors: social, environmental and financial. The current invention advantageously and optionally supports this new planning approach.

In accordance with the present invention there is a method for comparing investments in productive assets with investments in modifying demand for output of the productive assets, in an asset based business, the method comprising the steps of:

inputting objectives or constraints of the business;

retrieving data from one or more asset data structures each for storing data representing assets of the business, the assets having an ascertainable productive output with forecastable market value and having an associated attribute data structure for storing one or more attribute value corresponding to the financial and non-financial productive outputs, inputs, and associated impacts of an asset over a time period which relates to the useful productive life of the asset;

processing said retrieved data to generate a current and projected productive output set for a current asset investment comprising aggregated impact and costs attributes over time of selected asset investments;

retrieving consumer data from a demand data structure representing modified consumer demand corresponding to a requested demand side management program;

processing said retrieved consumer data to generate a modified consumer demand comprising aggregated impact and costs attributes over time of the requested demand side management program;

comparing all consolidated attributes of the asset investment, demand side management program, projected demand, current and projected productive output, and objectives and constraints of the business; and

identifying conflicts between the current asset investment, the requested demand side management program, and the objectives or constraints of the business.

A still further embodiment of the invention provides a system for comparing investments in productive assets with investments in modifying demand for output of the productive assets, in an asset based business, the system comprising:

A computer implemented process for:

inputting objectives or constraints of the business;

retrieving data from one or more asset data structures stored in a database each for storing data representing assets of the business, the assets having an ascertainable productive output with forecastable market value and having an associated attribute data structure for storing one or more attribute value corresponding to the financial and non-financial productive outputs, inputs, and associated impacts of an asset over a time period which relates to the useful productive life of the asset;

processing said retrieved data to generate a current and projected productive output set for a current asset investment comprising aggregated impact and costs attributes over time of selected asset investments;

retrieving consumer data from a demand data structure representing modified consumer demand corresponding to a requested demand side management program;

processing said retrieved consumer data to generate a modified consumer demand comprising aggregated impact and costs attributes over time of the requested demand side management program;

comparing all consolidated attributes of the asset investment, demand side management program, projected demand, current and projected productive output, and objectives and constraints of the business; and

identifying conflicts between the current asset investment, the requested demand side management program, and the objectives or constraints of the business.

Advantageously the current invention allows for analysis of investment in the demand side of an organization's business to be directly compared to investments in the supply side of a company's business both considered, independently and in combination, in light of an organizations' objectives thus yielding an integrated investment plan for the organization.

In accordance with a still further embodiment there is provided a system for modeling demand for output of productive assets, in an asset based business, the system comprising a database having one or more demand data structures each comprising device field for storing data representing a device which consumes said output of the productive assets; and an expenditure data structure associated with each device for storing one or more attribute values corresponding to cost and benefits of the device over a time period which relates to a load shape of said device.

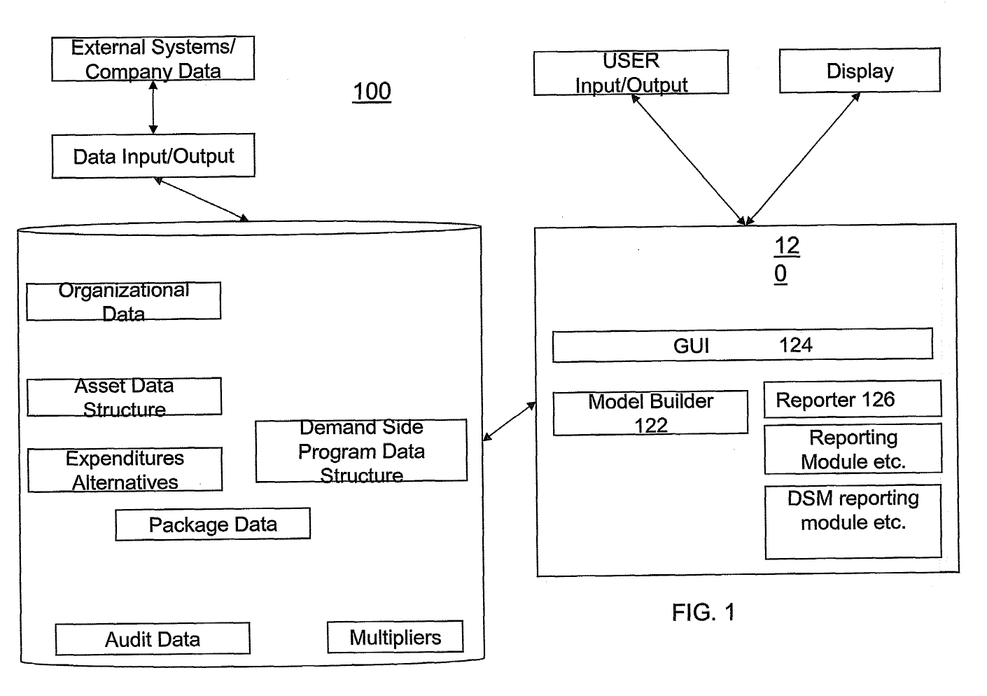

Referring to FIG. 1 there is shown components of a planning system 100 according to an embodiment of the present invention. The planning system 100 comprises a processing system 120 and a database 121 for storing identification of various items along with data associated with the items. The processing system includes a model builder 122 module which provides a user interface for users to create relationships between the items and data to create data models which model aspects of a business, and a reporter 126 for retrieving, modifying and processing data stored in the models. The models include an asset base model, and a demand model. The reporter also includes other modules or functions such as modules for optimisation, asset spending, determining customer or market demand, revenue forecasting, auditing, reporting and input/output with other business systems. Each of the modules may include their own graphical user interface (GUI) or share a common GUI 124 with other modules. The GUI's support user interaction and display of data and analytical results for the functions supported by the various modules. The models may be defined by a set of database tables (described later) which are stored in the database 121. This data may include organizational data 141, asset data, 142, expenditure alternatives 144, demand side program data 146, package data 148, audit data 150 and multiplier data 152.

The modules and their functions may be implemented via computer instructions (e.g., one or more software applications) executing on a server, or alternatively, on a computer device, such as a user system. If executing on a server, the user system may access the features of the system over a network (not shown). The data input/output module allows the system to interface with external data sources such as a business's financial and data warehouse and other computer systems. Included with the input/output module is email notification and communication functions for communication of results and reporting to various managers and users within a business to allow for easy collaboration between departments. For example the present invention allows workflow for the investment process to be managed at various steps in the process. This, in conjunction with an auditing function, allows each step to be delegated if needed while being monitored and recorded for audit. The system may be implemented using a general-purpose computer executing one or more computer programs for carrying out the processes described herein. The user system may be a personal computer (e.g., a laptop, a personal digital assistant) or a host attached terminal. If the user system is a personal computer, the processing described herein may be shared by the user system and the host system server (e.g., by providing an applet to the user system). User system may be operated by project team members or managers of the provider entity. Various methods of implementing the prediction and optimization functions may be employed as described further herein. Furthermore the database and the data structures implemented therein may also be implemented in a client server architecture and is preferably a relational database.

The storage device may be implemented using memory contained in the user system or host system or it may be a separate physical device. The storage device is logically addressable as a consolidated data source across a distributed environment that includes a network. Information stored in the storage device may be retrieved and manipulated via the host system and may be viewed via the user system.

### Model Builder 122

An advantage of the planning system 100 is an ability to configure models using the model builder module 122 by connecting various attribute items with organizational, asset, and demand side data to store a plurality of data records termed investment alternatives which is a model comprising projections in time of spending and benefits resulting from alternative asset or demand side investments. In other words a model is the relationship between the various item identifiers and its associated data. The models will be considered in more detail below. In most instances the data records in each model data structure includes values of attributes over predetermined time periods, typically over 30 to 50 years, within various time horizons (typically 1 to 5 years).

As will be seen later, the particular set of items or attributes chosen is determined by the particular business scenario being modeled i.e. asset investment, demand modelling etc.

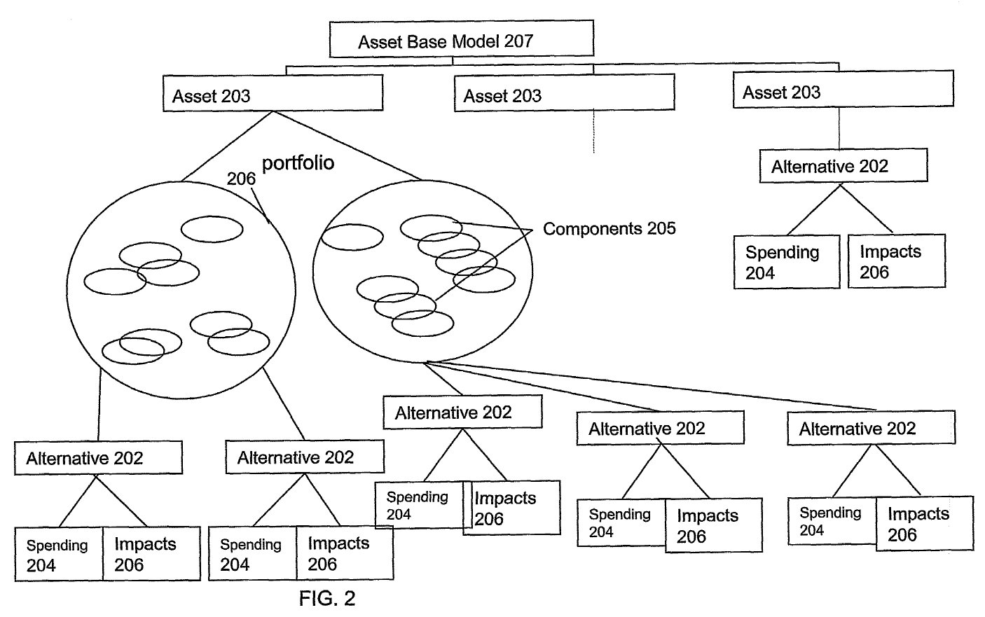

In addition the business scenario being considered will determine how sets of alternatives are related. For example if asset investment taking into account spending costs and benefits with respect to assets are to be modeled, a hierarchy of the companies asset base is created with component and asset nodes assigned to various spending, cost and benefits alternatives. This may be better illustrated by referring to FIG. 2 in which there is shown how the investment alternatives 202 are related hierarchically in an asset base model 207.

### Asset Model 207

The organizational and asset data items may be connected in a variety of relationships using the model builder 122. One way is to identify the asset hierarchy for the company. The asset hierarchy may link the underlying asset 203 and organizational data such that a plurality of data records which identify an organization's assets can be further linked to a plurality of components which identify an asset's constituent components. The model builder 122 allows the user to connect sets of spending, costs and benefit alternatives to components and link them through an asset hierarchy. In the illustrated embodiment, alternatives 202 are associated with each component but could be associated at any level of the hierarchy. Similarly, organizational relationships between departments, divisions etc. may be created using the model builder.

It is worth clarifying that the underlying data items are constructed as records of attributes which describe components 205, assets 203, organizational information etc., and that these records may be associated to each other in a variety of ways in addition to being associated through an asset hierarchy. For example, data records may be linked to allow records with similar expense type attributes, organizational class attributes, or project or portfolio attributes to be linked together for ease of parsing, selection and reporting. Although the current invention advantageously and uniquely provides for linkage through asset hierarchy, more conventional linkages through general ledger attributes such as deprecation class can also be provided to aid in reporting in this manner if so desired by the user.

The relationship between organizational objects exist in a tree structure and are meant to mimic the organizational structure of the company. Organizations exist in a hierarchy, and can have parent-child relationships. Advantageously in the current invention, because components 205 rather than their expenditures (spending and impacts) are related directly to the organizations, the organizational structure can be changed without serious repercussions to the planning system because assets and components, and their associated expenses and impact attributes, are related together. As mentioned earlier, components represent an asset, and like organizations, components can exist in a hierarchy and can relate to one another. This allows the user to model individual components (or groups of components or assets) separately from each other, then relate them together to create a business system. Users can then consolidate at or drill down to any detail within the hierarchy that they choose, or report against the attributes or consolidated attributes of the assets, components, or organization.

The organizational data may include data that represents the reporting structure of the company. The data included in the organizational model includes amongst others organizational name, definition, code, parent organization, role of organization (cost, revenue, profit, and investment), region, composite depreciation rate, headcount by job groups, and currency.

Furthermore the model builder 122 may be used to group components and assets into component portfolios and designate them as productive or non-productive. Productive portfolios may have data captured against them to enable modeling of supply capabilities (production and/or delivery) where such data can include capacity, primary product names, primary product production volumes by hour, week, month and year, primary product raw material inputs, primary product raw material conversion factors, by-product names, and by-product production volumes by hour, week, month, and year.

Thus the asset model includes sets of investment alternatives 202 associated with each component 205 or portfolio of components 206, be they designated productive or non-productive, and, possibly and additionally, with each asset. In other words an investment alternative represents a different spending path that can be taken given a particular project. As mentioned above, each investment alternative 202 comprises descriptive attribute data about the alternative as well as projections over time for both spending and impacts of that spending. It is notable that spending includes all expenditures of cash to be made by the company and impacts includes all benefits be they financial or non-financial to the company and its stakeholders that result from the considered alternative.

Accordingly, costs, benefits and expenditures in the business are populated in the model through a bottom-up approach, i.e. investment alternatives may be attached at a lowest level in an asset hierarchy and then rolled up to asset group, asset systems etc.

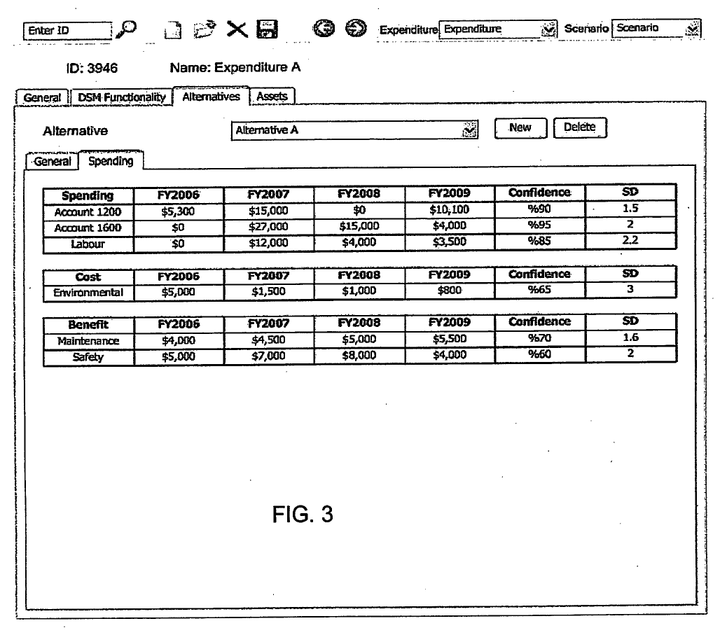

Referring to FIG. 3 there is shown an output on a screen display 300 of a report for a single investment alternative within a sample expenditure indicated as Expenditure A 302. The report shows items of: spending, cost and benefits and their associated list of values at a series of 1 year time horizons, over a period of 4 years, for each of the items. In addition to the time horizon value each item may also have associated therewith a confidence value or probability in relation to the accuracy of the value. It may be noted that these values are input by a user during population of the model data structure. The model builder 122 allows a user to input a plurality of sets of investment alternatives, each with a unique set of values and or attributes. The model builder 122 allows each set of alternatives to be associated with a particular component, asset or set of components or assets.

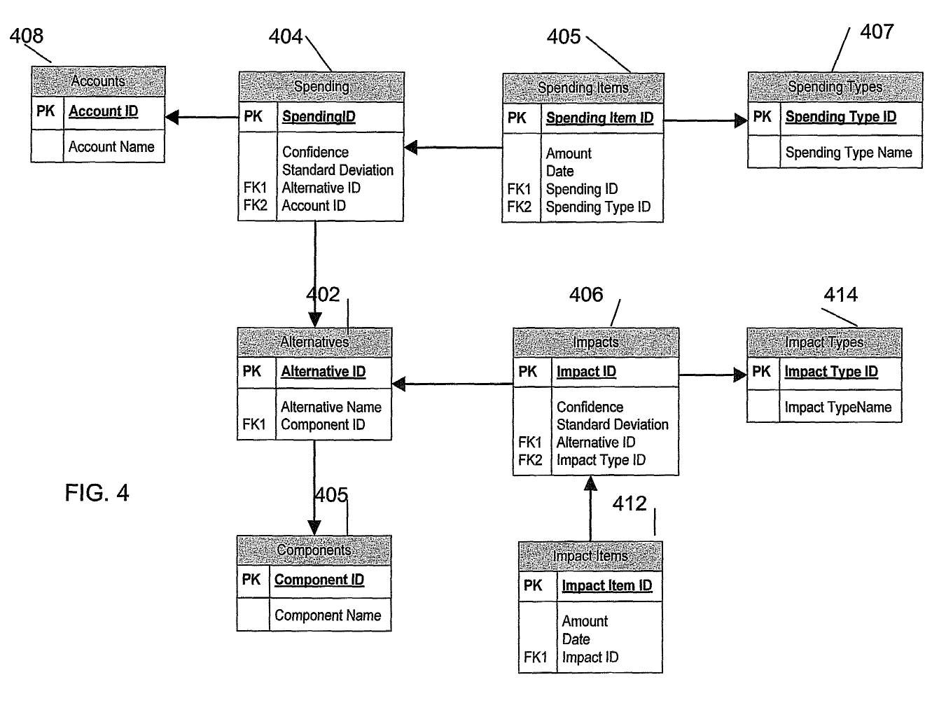

Referring to FIG. 4 there is shown an entity relationship diagram 400 representing the relationship between various entities in the investments alternatives data structure for creating an asset base model. In the diagram and arrow indicators a many to one relationship. This data structure is accessed via the model builder 122 module graphical user interface to allow a user to populate the asset hierarchy for a company or organization being modelled. A component table 405 is used to store identifiers for real objects, such as an electrical transformer or a generator, or a virtual object like a marketing team or an intellectual property portfolio. The component table 405 is related to an alternatives table 402 where each component 405 has a plurality of alternatives 402. A spending table 404 associates with each alternative 402 a collection of projected financial costs. This is where the cost header is stored. There is one record in this table for each spend type. This table stores the selected cost type, as well as the confidence and standard deviation. A Spend Items table 405 associates with each spending 404 a collection of spending items. The spending values are unique for each time period and are stored in nominal dollars. This table contains a collection of date/amount pairs to enable representation of the cost over time. A Spend Types table 407 stores a collection of cost types that are user defined and used by the system for costs. An accounts table 408 is associated with the spending table 404 and stores a collection of accounts that are user defined and used by the business for allocating spending. Each alternative in the alternatives table 402 has a collection of impacts which are incremental costs and benefits both financial and non-financial, that impact the company, its market or its environment, and that are projected to be incurred as a result of the spend. This is where the impact header is stored. There will be one record in this table for each impact on the user interface. This table stores the selected impact type, as well as the confidence and statistical standard deviation associated with the nominally provided value. Each impact has a collection of impact items stored in an impact items table 412. The impact values may change over time and thus this table contains a collection of date/amount pairs to represent the impact over time. An impact types table 414 stores a collection of impact types that are user defined and used by the system for impact. Note that non-financial impacts may be related to financial values through the application conversion factors stored in Economic Indicators data structure 130. For example, cost of reliability, safety or environmental impact can be reduced from impact specific units, such as tons of carbon per year, accidents per year, or up time, to a financial metric through the application of these conversion factors which assign a financial cost or benefit to the non-financial attribute. Note that such an optional conversion of non-financial attributes to financial values is useful in a simplistic utility analysis where conversion of all cost and impact attributes of investment scenarios are compared by their stream of net financial benefit, wherein these financial benefits may further be reduced to a single number for each investment scenario through discounted cash flow techniques.

### Packages

In addition the model builder 122 provides a set of tools for users to more efficiently populate the models, by allowing a user to create packages of attribute data that are absolute time independent. For example, in the context of assigning spending attribute values for the supply side spending described above, the model builder module 122 provides the user with two options to assign spending attribute values over time to particular expenditures. A first option is to assign the spending by directly entering absolute values to the attributes associated with the expenditure. A second option is to assign the spending to a so called “package”, and then assign the package to the expenditure. The package is a matrix of attributes and their values (often but not essentially dollar values) over relative time, for a group of spending attributes. For example if the organization owns a fleet of vehicles then a vehicle repair package may be constructed as follows:

TABLE 1

| Item | Month 1 | Month 2 | Month 3 | Month 4 | Month 5 | Month 6 | Month 7 | Month 8 |
|---|---|---|---|---|---|---|---|---|
| Oil Change | | | $50 | | | $50 | | |
| Tire Rotation | | | | | $100 | | | |
| Inspection | | | | $150 | | | | $150 |

In the above table, the package indicates that no matter when a vehicle is purchased, the organization will need to spend money on an oil change 3 months later (amongst other costs).

Once the package is created, a user simply need create a vehicle repair expenditure matrix of the number of vehicles on hand in absolute (actual) time as below:

TABLE 2

| | | | | | | | | |
|---|---|---|---|---|---|---|---|---|
| Item | January 2007 | February 2007 | March 2007 | April 2007 | May 2007 | June 2007 | July 2007 | August 2007 |

| | | | | | |
|---|---|---|---|---|---|
| vehicle Repair | 10 | 10 | 10 | 5 | 5 |

Assuming the organization plans on purchasing many vehicles throughout the year the package can be applied to an expenditure for a single year or across all years in Table 2 to convert the package of expenditure attributes (table 1) from relative time to absolute time. Thus the reporter module will multiply out the packages into the expenditure attributes, to get the actual cost attributes in absolute time as shown below in Table 3:

TABLE 3

| Item | January 2007 | February 2007 | March 2007 | April 2007 | May 2007 | June 2007 | July 2007 | August 2007 |
|---|---|---|---|---|---|---|---|---|
| Oil Change | | | $500 | $500 | $500 | $750 | $750 | $500 |
| Tire Rotation | | | | | $1000 | $1000 | $1000 | $500 |
| Inspection | | | | $1500 | $1500 | $1500 | $750 | $2250 |

The user may be able to assign lump resource saving (i.e. simulate different resource expenditure scenarios) directly to the expenditure, or through the package. These value attributes represent the amount of resources that will not be used if the expenditure is implemented. This is assuming that the user has already calculated the amount of resource saving an event will have on their own, and only wants to use the planning system to aid them in running reports on that saving.

Thus it may be seen that the package is a “modular component” which are consolidated by the Reporter, wherein the Reporter can provide both translation (in time) and scaling (in number) functions to the packages before consolidating the resulting impact and expense attributes in absolute time for the user to review (or store for future manual or automatic analysis).

### Demand Model

The asset data structures and modules in FIGS. 2-4 above have been primarily described as they relate to the supply side of a business, however they are additionally useful to model the demand side of a business. In modelling the demand side independently or in addition to modelling the supply side of a business the general question to be answered is “what is the effect on the business with respect to its business objectives and constraints as a result of investing to change customer demand for products or services of the business and additionally whether this is preferred to investing in the supply side of the business?”

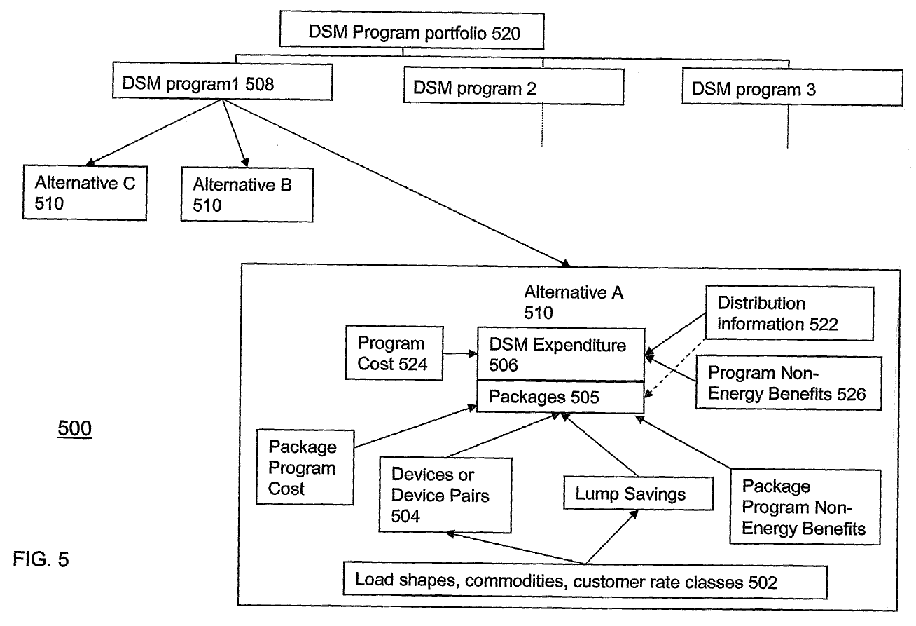

Referring to FIG. 5 there is shown a conceptual diagram 500 of a demand model data structure. The demand model is defined around elemental data records which model the effect over time of the planned Demand side management (DSM) activity on an individual consumer or group of consumers. In the present embodiment this elemental data record is a notional construct called a device record, or device pair record, 504 so described because DSM programs, as commonly used to modify consumer demand for electrical power in the context of the power industry, are often delivered through incenting consumers to purchase physical devices like compact fluorescent light bulbs, or power efficient appliances. It should be noted however that the device 504 construct may also be used to model the effect or actions over time of any consumer or group of consumers in response to an incentive offered by the business whether it is tied to the use of a physical device or not, i.e. a device record can be used to model the decreased demand for power by a consumer in peak use periods as a result of direct rebate payments from the business to incent the consumer to avoid use of power in those peak periods. Advantageously, the packages data structure previously described can be used to good effect to model the modular and elemental nature of these device records or device pair records.

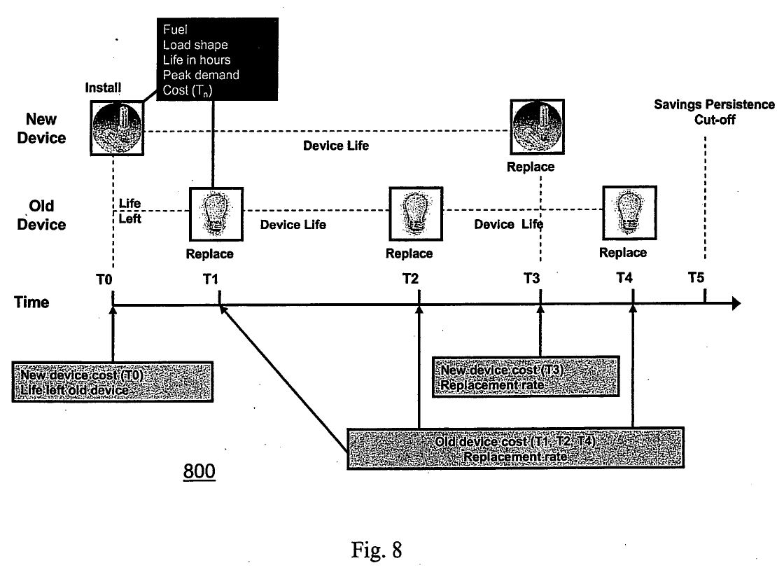

These devices 504 may be characterised by a number of attributes which may be stored as packages 505 having a sequence of attribute values independent of absolute time and therefore the model builder 122 allows users to assemble DSM expenditures 506 into DSM Programs 508 in a hierarchical structure of parent-child dependencies and set-up multiple DSM expenditure alternatives 510, similar to the creation of the asset base model described earlier Further the model builder 122 allows users to create the end-use devices 504 (in the present context a physical device is any product or service that consumes a product or service generated by the business) and deploy them in pairs to simulate the non-DSM or status quo projection by comparison to the DSM or changed projection, for example a retrofit or replacement situation (as described later with reference to FIG. 8), or instead forecast savings in lump fashion. The model builder also allows users to create the packages 505 of program components whose volume can be deployed and adjusted over multiple time periods. Furthermore, model adjustment factors such as free-ridership (physical devices that consume more than their fair share of a resource), cross-effects, and others can be accounted for.

As may be seen in FIG. 5, at a very top of the hierarchy is a DSM expenditure portfolio 520, which comprises a collection of the DSM programs 508 or projects. Each DSM program 508 includes one or more DSM expenditures 510 referred to as DSM alternatives. The DSM expenditure inputs data from costs, packages, optional lump savings and non-energy benefits. The packages are created from devices and lump savings. In addition the DSM expenditure may include a reference to Distribution information 522, which indicates to a subsequent report which DSM package 505 to use when generating DSM reports (described later). DSM program costs 524 and DSM program non-energy benefits 526 may also be attached to a DSM expenditure 506 and/or packages 505.

Similar to the asset base model 207 the model builder 122 may be used to build and populate a market demand model 500 data structure describing the investments, impacts and consolidated demand projected over time for the company's products and services. The attributes of the data structure 500 for the demand model differ from the asset base model 207 in that the demand model data structure stores data on the types of commodities that customers want to buy, commodity prices, timing of demand and volumes demanded, load shapes and customer rate classes 502. If this data is expected to vary over time, then several data points per data type are provided as a time series. Examples of data captured includes commodity name, customer identification, customer class, customer (class) region, customer class demanded commodity, customer (class) commodity demanded volume and time of demand (by hour, week, month and year), input commodity price forecasts and customer (class) commodity rate forecasts. Various demand alternatives can be created to model various demand scenarios for different combinations of attribute values.

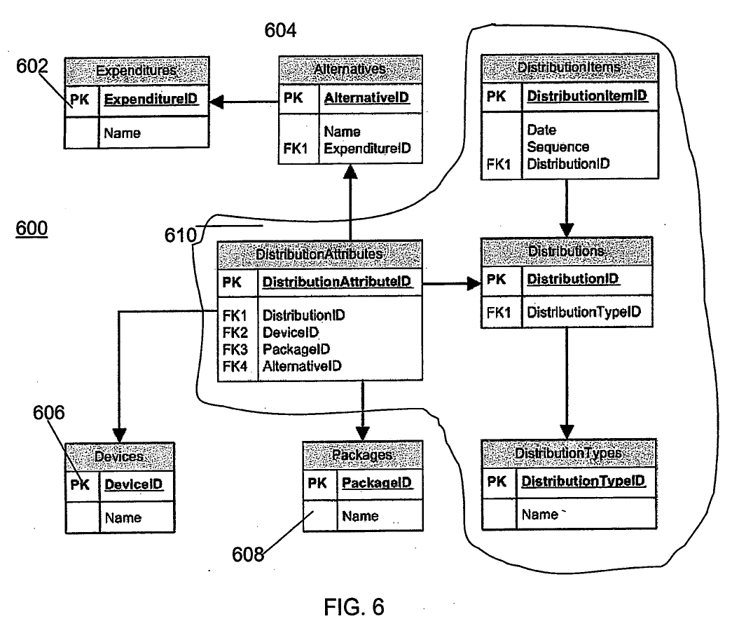

Referring to FIG. 6 there is shown an entity relationship diagram 600 for implementing a DSM alternative 510 data structure. The entities include expenditures 602, alternatives 604, devices 606, packages 608 and distributions 610 related in the manner as illustrated. More specifically, the devices table includes device field for storing data representing an identity of a physical device which consumes an output product or service supplied by the business.

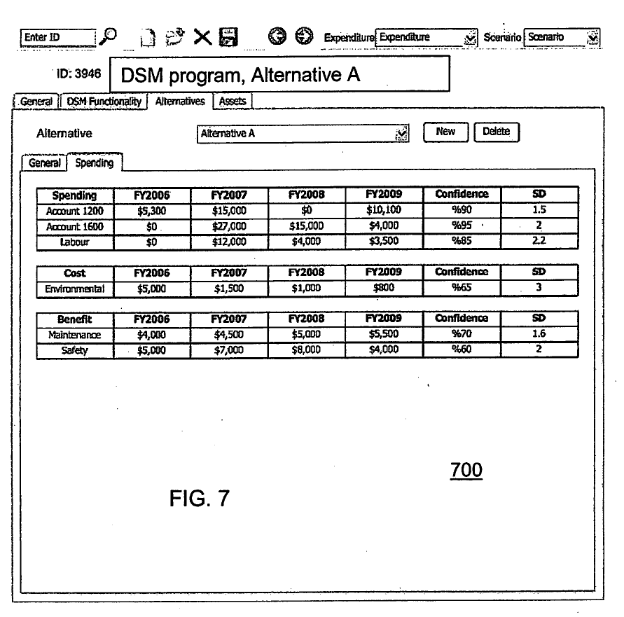

Referring to FIG. 7 there is shown a screen display 700 of data for a single DSM program alternative.

The devices 504 construct used in the DSM data structure may typically include the following attributes:

Load Shape—This is the amount of time the device will be active in an hourly or monthly grain. In production multipliers (described later) this value along with the “life in hours” value is used to generate the total expected life of the device.

Life in Hours—This is how many hours of life the device has. This value represents the expected life of the device given %100 usage.

Replacement Rate—When the device fails, this is the percentage of time the device will actually be replaced.

Removal Rate—Every month a certain percentage of these devices is removed without being replaced. This is the value that represents that.

Installed Cost—This is the total cost to replace the device. This value is stored in absolute time, and can change over time (A device will likely get less expensive over time).

Furthermore the model builder 122 allows devices to be categorized as follows:

Standard Device:

This is a basic device that the users can associate with an expenditure. The DSM reports can consolidate and thereby calculate how much the device will cost over time using the device attributes.

Control Device:

This is a device which has an effect on other devices usage (A dimmer switch, for example). When attaching this device to an expenditure, the user must choose a list of devices this will affect. Once the devices are chosen, the user must enter how many of each device is effected, and the percentage they will be affected.

Replacement Device:

This is a device which will replace another device. The user must choose both the legacy device, and the new device. The user can enter a percentage of life left for the legacy device when it is initially replaced. A good example of a replacement device would be replacing an old fridge with a newer, energy efficient fridge.

Delta Device:

This is a device that represents the difference between a legacy device and the replacement device. This is a shortcut for replacement device scenario. Instead of setting up a device pair and then calculating the benefits/costs of replacing a legacy device, users can enter the difference between legacy and replacement attributes directly by configuring a delta device.

The use of the DSM data structure 500 with the notion of device pairs may be better understood by first referring to an example. Accordingly, referring to FIG. 8 there is shown a schematic diagram 800 of device pair relationship. In this device pair relationship, assume utility company for example ABC Utility Inc., offers a light bulb replacement program to its customers where an old inefficient device (e.g. incandescent light bulb) is replaced by a new efficient one (e.g. compact fluorescent light). In addition, the utility offers an incentive of $5/bulb for the consumer to purchase a new efficient bulb with the expectation it will replace an old inefficient bulb. These represent a typical participant offer, of which a percentage, say 20% are assumed to be free-riders. This data is input and entered in a DSM package to address the scenario where a customer has elected to participate in the DSM program with its resulting elemental cost and impacts on them and the business, i.e. “do I replace my incandescent bulb with a compact fluorescent bulb?”. The expenditure to be determined with this DSM program includes utility fixed costs (e.g. advertising) plus the forecast number of customer participants in a program (say 250,000 over 3 years).

A DSM expenditure portfolio is constructed which contains several different kinds of programs, which maybe, for example, specific to different customer sectors (i.e. residential, commercial, industrial).

When considering an elemental device pair where a new device is replacing an old existing device, every device, both new and old, needs to be kept track of during its life, to know when it needs (or would have needed) to be replaced. In addition to the energy savings relationship which exists between the 2 devices, there is a long-run cost relationship, in terms of the cost of device replacement. When devices are replaced a replacement rate can be configured (i.e. other than 100%), or each year a certain number of devices may be removed. These factors have the effect of modifying the energy savings which the utility can claim. By forecasting the number and timing of customer participants who are expected to make use of this device, the reporter can consolidate the expense, impact on demand and other impacts of the cumulative demand side management program. Alternatives can also be constructed which vary either at the device level, for example with different rebate levels or more or less efficient replacement devices, or at the program level, for example more or less invested in program advertising, or a higher or lower projected customer participation, so that alternative DSM programs or assumptions can be readily compared.

Thus as mentioned below the reporter can generate the DSM penultimate report called cost-effectiveness reports. All the variables from the DSM programs, from devices, packages, expenditures and programs, which are calculated and rolled-up from an expenditure level to DSM Programs, Customer Sectors, and ultimately the overall DSM investment portfolio.

It may be seen that by combining reports from the asset base model and DSM model that the planning system may be used to simulate the effects of spending internally (asset investment) or external (modification of consumer demand) or both. Accordingly, referring back to FIG. 5 and considering the example of the light bulb device described above, the planning process would follow the steps now described. The user uses the asset model to first determine a current supply for a given investment. The user then creates, using the model builder 122 an existing demand side model for consumer light bulb usage model. The reporter then projects the required supply by the business under the existing demand model. The user may then decide to reduce this required supply by providing consumers with an incentive DSM program to replace light bulbs with more efficient light bulbs, and a new required supply can be projected (presumably lower). The asset base model then is used to determine asset investment expenditures for this new (presumably reduced) supply.

The inverse of this example is of course more generally applicable where investment in demand side marketing programs are used to incent increased customer demand for a businesses products and services which must then be matched to increased supply, generally as a result of supply side investment in the business. Advantageously the current invention can be used to model this more general marker-side/supply-side scenario as well.

DSM allows a user to capture data and model the alternative costs incurred by the organization as a result of choosing to invest in modifying customer demand for their product or service as a separate investment alternative. As a further analysis and investment alternative the organization can then consider the resulting changes in investment in the supply side model necessary to provide the product at the new demand level.

For example in the context of a power generation plant, electrical load demand is managed by peak shaving of the electrical load curve, i.e. DSM. This approach is intended to increase the utilization and the efficiency of the electrical power system, and thereby postpone investments in the transmission or the distribution system, and/or in installed generation capacity. DSM according to the present invention provides for the following:

DSM Modeling and Analysis

DSM modeling and analysis may provide for the construction of DSM Programs by comparing the costs and benefit impacts of different combinations of end-use devices or other incentives, based on customer load shapes; model impacts of legislative changes, time-based pricing, and load-shifting; forecast impacts for multiple commodities (e.g. electricity, gas, water); run standard DSM tests (Utility Test, Rate Impact Test, Participant Test, Total Resource Cost Test) using both forecasts and actuals; perform powerful and insightful scenario, sensitivity and critical values analysis.

DSM Planning

DSM planning allows for the assembly of long-term Plan Scenarios involving mixes of DSM Programs and alternatives; freeze, update, re-freeze, approve and un-approve DSM Plans; build Programs at department and account level to make budgeting more efficient.

DSM Reporting

DSM reporting allows for the production of different types of reports (costs & lost revenues, benefits, resource savings, emissions impacts, cost-effectiveness); Track and report DSM Program actual costs and energy savings and cost effectiveness. (Details of DSM reporting will be discussed later)

For example, referring to the table structure of FIG. 6, an example of using expenditures and packages in DSM reporting is explained as follows. More specifically this example illustrates the construction of packages which capture costs not just at the device level, but the creation of a hierarchy of DSM packages which incorporate the device level spending packages with device usage(load shape) for one or more scenarios. For this example, let's assume the user has created via the model builder 122 a single DSM program called “Light Office”. After that, the user wishes to create two DSM alternatives: “Use Lamps” and “Use Ceiling Lights” each as a package of attributes not fixed in time permitting either of “Use Lamps” or “Use Ceiling Lights” to be linked to other investment scenarios which will fix their attributes in time. Each of these DSM alternatives is based on respective devices that have different costs and load shapes over time, namely: “Lamp” and “Ceiling Light”. Accordingly, the following sequence of tables show the data records that are created in the table structure 600:

Expenditures

| ExpenditureID | Name |
|---|---|
| 0 | Light Office |

Alternatives

| AlternativeID | Name | ExpenditureID |
|---|---|---|
| 12 | Use Lamps | 0 |
| 13 | Use Ceiling Lights | 0 |

Packages

| | |
|---|---|
| PackageID | Name |

Devices

| DeviceID | Name |
|---|---|
| 4 | Lamp |
| 5 | Ceiling Light |

DistributionTypes (system meta-data)

| DistributionTypeID | Name |
|---|---|
| 24 | Packages |
| 25 | Devices |
| 26 | Installed Cost |

Distributions

| | |
|---|---|
| DistributionID | DistributionTypeID |

Distribution Attributes

| | | | | |
|---|---|---|---|---|
| DistributionAttributeID | AlternativeID | PackageID | DeviceID | DistributionID |

Distribution Items

| | | | | |
|---|---|---|---|---|
| DistributionItemID | DistributionID | Value | Date | Sequence |

Now that the user has entered basic setup information, they will want to detail out how much the ceiling lights and lamps cost to install. The table below shows the difference in the installed costs for the alternatives Lamp and Ceiling light:

| | | Ceiling Light |
|---|---|---|
| Date | Lamp Cost | Cost |
| January, 2009 | $20 | $30 |
| February, 2009 | $21 | $30 |
| March, 2009 | $22 | $40 |
| April, 2009 | $25 | $40 |

And based on that information, here is how the table data would look now:

Expenditures

| ExpenditureID | Name |
|---|---|
| 0 | Light Office |

Alternatives

| AlternativeID | Name | ExpenditureID |
|---|---|---|
| 12 | Use Lamps | 0 |
| 13 | Use Ceiling Lights | 0 |

Packages

| | |
|---|---|
| PackageID | Name |

Devices

| DeviceID | Name |
|---|---|
| 4 | Lamp |
| 5 | Ceiling Light |

DistributionTypes (required system meta-data)

| DistributionTypeID | Name |
|---|---|
| 24 | Packages |
| 25 | Devices |
| 26 | Installed Cost |

Distributions

| DistributionID | DistributionTypeID |
|---|---|
| 8 | 26 |
| 9 | 26 |

Distribution Attributes

| DistributionAttributeID | AlternativeID | PackageID | DeviceID | DistributionID |
|---|---|---|---|---|
| 56 | NULL | NULL | 4 | 8 |
| 57 | NULL | NULL | 5 | 9 |

Distribution Items

| DistributionItemID | DistributionID | Value | Date | Sequence |
|---|---|---|---|---|
| 81 | 56 | 20 | January, 2009 | NULL |
| 82 | 56 | 21 | February, 2009 | NULL |
| 83 | 56 | 22 | March, 2009 | NULL |
| 84 | 56 | 25 | April, 2009 | NULL |
| 85 | 57 | 30 | January, 2009 | NULL |
| 86 | 57 | 30 | February, 2009 | NULL |
| 87 | 57 | 40 | March, 2009 | NULL |
| 88 | 57 | 40 | April, 2009 | NULL |

The user now knows how much each lighting device will cost to install for four consecutive months (in relative but not absolute time). Now the user wants to create two generic DSM packages independent of time: One that maps out the lamps required to light an office, another that maps the ceiling lights that must be used. The user knows that lights will be installed over a period of two months. The user decides the values should look like this:

| Month | # Lamps | # Ceiling Lights |
|---|---|---|
| 1 | 4 | 3 |
| 2 | 2 | 1 |

Expenditures

| ExpenditureID | Name |
|---|---|
| 0 | Light Office |

Alternatives

| AlternativeID | Name | ExpenditureID |
|---|---|---|
| 18 | Use Lamps | 0 |
| 19 | Use Ceiling Lights | 0 |

Packages

| PackageID | Name |
|---|---|
| 32 | Light Office With |
| | Lamps |
| 33 | Light Office With |
| | Ceiling Lights |

Devices

| DeviceID | Name |
|---|---|
| 4 | Lamp |
| 5 | Ceiling Light |

DistributionTypes (required system meta-data)

| DistributionTypeID | Name |
|---|---|
| 24 | Packages |
| 25 | Devices |
| 26 | Installed Cost |

Distributions

| DistributionID | DistributionTypeID |
|---|---|
| 8 | 26 |
| 9 | 26 |
| 10 | 25 |
| 11 | 25 |

Distribution Attributes

| DistributionAttributeID | AlternativeID | PackageID | DeviceID | DistributionID |
|---|---|---|---|---|
| 56 | NULL | NULL | 4 | 8 |
| 57 | NULL | NULL | 5 | 9 |
| 58 | NULL | 32 | 4 | 10 |
| 59 | NULL | 33 | 5 | 11 |

Distribution Items

| DistributionItemID | DistributionID | Value | Date | Sequence |
|---|---|---|---|---|
| 81 | 8 | 20 | January, 2009 | NULL |
| 82 | 8 | 21 | February, 2009 | NULL |
| 83 | 8 | 22 | March, 2009 | NULL |
| 84 | 8 | 25 | April, 2009 | NULL |
| 85 | 9 | 30 | January, 2009 | NULL |
| 86 | 9 | 30 | February, 2009 | NULL |
| 87 | 9 | 40 | March, 2009 | NULL |
| 88 | 9 | 40 | April, 2009 | NULL |
| 89 | 10 | 4 | NULL | 1 |
| 90 | 10 | 2 | NULL | 2 |
| 91 | 11 | 3 | NULL | 1 |
| 92 | 11 | 1 | NULL | 2 |

Finally, the user wants to light ten offices (four in January of 2009, six in February of 2009). Rather than going through the trouble of creating a new DSM expenditure, the user can simply use the DSM package “light office” as shown below.

Expenditures

| ExpenditureID | Name |
|---|---|
| 0 | Light Office |

Alternatives

| AlternativeID | Name | ExpenditureID |
|---|---|---|
| 18 | Use Lamps | 0 |
| 19 | Use Ceiling Lights | 0 |

Packages

| PackageID | Name |
|---|---|
| 32 | Light Office With |
| | Lamps |
| 33 | Light Office With |
| | Ceiling Lights |

Devices

| DeviceID | Name |
|---|---|
| 4 | Lamp |
| 5 | Ceiling Light |

DistributionTypes (required system meta-data)

| DistributionTypeID | Name |
|---|---|
| 24 | Packages |
| 25 | Devices |
| 26 | Installed Cost |

Distributions

| DistributionID | DistributionTypeID |
|---|---|
| 8 | 26 |
| 9 | 26 |
| 10 | 25 |
| 11 | 25 |
| 12 | 24 |
| 13 | 24 |

Distribution Attributes

| DistributionAttributeID | AlternativeID | PackageID | DeviceID | DistributionID |
|---|---|---|---|---|
| 56 | NULL | NULL | 4 | 8 |
| 57 | NULL | NULL | 5 | 9 |
| 58 | NULL | 32 | 4 | 10 |
| 59 | NULL | 33 | 5 | 11 |
| 60 | 18 | 32 | NULL | 12 |
| 61 | 19 | 33 | NULL | 13 |

Distribution Items

| DistributionItemID | DistributionID | Value | Date | Sequence |
|---|---|---|---|---|
| 81 | 8 | 20 | January, 2009 | NULL |
| 82 | 8 | 21 | February, 2009 | NULL |
| 83 | 8 | 22 | March, 2009 | NULL |
| 84 | 8 | 25 | April, 2009 | NULL |
| 85 | 9 | 30 | January, 2009 | NULL |
| 86 | 9 | 30 | February, 2009 | NULL |
| 87 | 9 | 40 | March, 2009 | NULL |
| 88 | 9 | 40 | April, 2009 | NULL |
| 89 | 10 | 4 | NULL | 1 |
| 90 | 10 | 2 | NULL | 2 |
| 91 | 11 | 3 | NULL | 1 |
| 92 | 11 | 1 | NULL | 2 |
| 93 | 12 | 4 | January, 2009 | NULL |
| 94 | 12 | 6 | February, 2009 | NULL |
| 95 | 13 | 4 | January, 2009 | NULL |
| 96 | 13 | 6 | February, 2009 | NULL |

### Reporting

An effective planning system requires users have the flexibility to enter data quickly, and to report on that data quickly. Accordingly, the reporter 127 provides not only reporting on the data as it was entered, but the ability to perform complex matrix calculations, such as illustrated above, on the entered data in order to produce reports on such things as revenue, varying consumer demand for the organizations products and services as well as the effect of the usage of consumable devices within the organization and their impact on the various investment alternatives described above. Also, the planning system 100 is able to model various changes to consumer demand and their effect on investment viability, i.e. the effect of changing consumer demand.

Thus the reporter 127 generates various reports and provides a collection of functions and procedures for users to access data stored in the system. In conjunction with the reporter 127, the packages data 148 and functionality may be extended to apply to more complex planning scenarios. As for example described above for calculating consumable device life times, like incandescent or fluorescent light bulbs, to be used in comparing various scenarios for determining how much money and energy can be saved by installing control and replacement devices. These devices may be characterised by a number of attributes which are stored as packages and used by the report.

The calculation of values by the reporter 127 may be better understood by referring to a specific example such as light bulb device. Assume a device termed Device A has the following parameters:
Life=3 months (calculated from the life in hours multiplied by the usage)
Replacement rate=%50
Removal rate=%10

Device A is assigned to an expenditure like this (For simplicity, each device deployment is shown in its own row):

TABLE 4
deployed devices

| | | | | | | | | |
|---|---|---|---|---|---|---|---|---|
| Item | January 2007 | February 2007 | March 2007 | April 2007 | May 2007 | June 2007 | July 2007 | August 2007 |

| | | | |
|---|---|---|---|
| Device A | 10 | | |
| Device A | | 10 | |
| Device A | | | 10 |

To find the total device volumes, we must first take the device values that have been assigned to the expenditure, and move them out to eternity:

TABLE 5
device volumes

| Item | January 2007 | February 2007 | March 2007 | April 2007 | May 2007 | June 2007 | July 2007 | August 2007 |
|---|---|---|---|---|---|---|---|---|
| Device A | 10 | 10 | 10 | 10 | 10 | 10 | 10 | 10 |
| Device A | | 10 | 10 | 10 | 10 | 10 | 10 | 10 |
| Device A | | | 10 | 10 | 10 | 10 | 10 | 10 |
| Total Volume | 10 | 20 | 30 | 30 | 30 | 30 | 30 | 30 |

The above are correct device volumes only if we assume that the devices, once installed, will last forever and never be removed. However, In order to get more realistic numbers, we must first factor in the device life. The device has a life of three months. Once we factor that in, we get these values:

TABLE 6

| | | | | | | | | |
|---|---|---|---|---|---|---|---|---|
| Item | January 2007 | February 2007 | March 2007 | April 2007 | May 2007 | June 2007 | July 2007 | August 2007 |

| | | | | | |
|---|---|---|---|---|---|
| Device A | 10 | 10 | 10 | | |
| Device A | | 10 | 10 | 10 | |
| Device A | | | 10 | 10 | 10 |
| Total Volume | 10 | 20 | 30 | 20 | 10 |

These values are correct assuming that the devices, once their life is over, never get replaced. However if Device A will be replaced 50% of the time. Then the device volumes are as per the table below once we factor in the replacement rate:

TABLE 7

| Item | January 2007 | February 2007 | March 2007 | April 2007 | May 2007 | June 2007 | July 2007 | August 2007 |
|---|---|---|---|---|---|---|---|---|
| Device A | 10 | 10 | 10 | 5 | 5 | 5 | 2.5 | 2.5 |
| Device A | | 10 | 10 | 10 | 5 | 5 | 5 | 2.5 |
| Device A | | | 10 | 10 | 10 | 5 | 5 | 5 |
| Total Volume | 10 | 20 | 30 | 25 | 20 | 15 | 12.5 | 10 |

The above table is now a more accurate view of the device volumes. The last item to consider is the removal rate. Each month, %10 of the devices are removed. Once we factor those in, we get the final device volumes:

TABLE 8

| Item | January 2007 | February 2007 | March 2007 | April 2007 | May 2007 | June 2007 | July 2007 | August 2007 |
|---|---|---|---|---|---|---|---|---|
| Device A | 10 | 9 | 8.1 | 3.6 | 3.3 | 3 | 1.3 | 1.2 |
| Device A | | 10 | 9 | 8.1 | 3.6 | 3.3 | 3 | 1.3 |
| Device A | | | 10 | 9 | 8.1 | 3.6 | 3.3 | 3 |
| Total Volume | 10 | 19 | 27.1 | 20.7 | 15 | 9.9 | 7.6 | 5.5 |

One thing to consider about the removal rate is it also affects the number of devices that get replaced once their life is over (because there are less of them to replace). You can multiply the above device volumes by the devices maintenance cost to get an accurate view of what the costs will be for that device.

Once we have the total device volumes, we can remove the unnecessary ongoing device volumes and are left with the installed devices. The only time a device is considered “installed” is when it is first installed or when it is replaced. This is dictated entirely by the device life. The device life is 3 months, so that means every 3 months (per line item) the device volume has been replaced, and is therefore an installed device:

TABLE 9

| Item | January 2007 | February 2007 | March 2007 | April 2007 | May 2007 | June 2007 | July 2007 | August 2007 |
|---|---|---|---|---|---|---|---|---|
| Device A | 10 | | | 3.6 | | | 1.3 | |
| Device A | | 10 | | | 3.6 | | | 1.3 |
| Device A | | | 10 | | | 3.6 | | |
| Total Volume | 10 | 10 | 10 | 3.6 | 3.6 | 3.6 | 1.3 | 1.3 |

The reporter 126 has now provided an accurate depiction of what the installed device volume looks like. The reporter multiplies the above installed volumes with the device installed cost, their power requirements, load shapes, etc., to generate values which can be displayed to the user to provide an accurate picture of how much investment is required to subsidize the sale of new devices and the cumulative impact of the program on power demand and any non-financial impacts.

Using the above tables, the reporter can display, or store for additional analysis, how much money and energy can be saved by various DSM investment scenarios and alternatives considered and compared independently and interpedently: i.e.: 200 light bulbs alone vs. 200 light bulbs at 50% plus a control device.

Thus it may be seen that packages are used to group items together to be attached to an expenditure. The model builder 122 allows a user to attach various spending items to a package in relative time, and then the reporter 127 can attach them to the expenditure in absolute time. Any cost, benefit or spending value can be included in the package.

The reporter module 126 also allows a user to compare the difference in energy usage between different physical devices as well as compare costs. For example, let's say we have two physical devices and we would like to compare the replacement: of an old fridge (GE1972) with a new fridge (GE2007) to determine what the energy usage and cost differences will be. We can setup a case where the legacy device is GE1972 and the new device is GE2007.

The device information is as follows:

### GE1972:

Life Left=40%
Device life=5 years
Energy Usage=1000 units per month. *
Installed Cost=$1000 (Assuming the customer can purchase a new one of that same model) **

### GE2007:

Life Left=100% (This is the new device, it is purchased new)
Device life=4 years
Energy Usage=300 units per hour month. *
Installed Cost $2000 **
Cost of energy=$0.05 per unit to sell to residential customers
* (Calculated from the device load shapes * energy usage per hour).
** (Installed cost is curved over time. The same device may cost more or less depending on the date it is purchased).

Using the above information, as well as the previous load shape example, the reporter can calculate the on-going and installed volumes for both devices:

| Item | 2007 | 2008 | 2009 | 2010 | 2011 | 2012 | 2013 | 2014 | 2015 | 2016 | 2017 | 2018 |
|---|---|---|---|---|---|---|---|---|---|---|---|---|
| GE1972-Installed | 0 | 0 | 1 | 0 | 0 | 0 | 0 | 1 | 0 | 0 | 0 | 0 |
| GE2007-Installed | 1 | 0 | 0 | 0 | 1 | 0 | 0 | 0 | 1 | 0 | 0 | 0 |
| GE1972-Ongoing | 1 | 1 | 1 | 1 | 1 | 1 | 1 | 1 | 1 | 1 | 1 | 1 |
| GE2007-Ongoing | 1 | 1 | 1 | 1 | 1 | 1 | 1 | 1 | 1 | 1 | 1 | 1 |

Using this 12 year table, we can calculate what the cost and energy savings will be for each device. First, we need to calculate what the cost and usage will be for each device:

GE1972 Energy Usage=1000*12 (months in a year)=12000 units per year or 144000 units over the 12 year period.

GE2007 Energy Usage=300*12 (months in a year)=3600 units per year or 43200 units over the 12 year period.

144000-43200=100800 units of energy would be saved by switching from the old fridge to the new fridge over a 12 year period. Now we can figure out the actual dollar value of the savings over the 12 year period:

GE1972 Installed Cost=2 deployments*$1000=$2000

GE2007 Installed Cost=3 deployments*$2000=$6000

GE1972 Ongoing Cost=144000 (units of energy)*$0.05=$7200

GE2007 Ongoing Cost=43200 (units of energy)*$0.05=$2160

GE1972 Total Cost=$2000+$7200=$9200

GE2007 Total Cost=$6000+$2160=$8160

Using the above calculations, we can conclude that switching from the new device to the legacy device will mean a 100800 unit savings for the energy company and a $1040 savings for the customer. Note that if the model builder 122 has constructed a DSM program alternative involving multiple customers implementing this device program, then the reporter can the be used to additionally consolidate and report the cumulative benefit from multiple such device installations.

### Multipliers

As may be noted from the above, the reporter is required to perform complex matrix operations when generating requested reports. These operations are computationally and time intensive.

One solution to speed reporting provided by the present invention to mitigate the above computationally intensive load is based on the observation that the algorithms and equations used for the overall calculations, which were too computationally expensive to process quickly, could be remodeled and reformulated into two parts, with one part being pre-computed and results stored for later retrieval and use, while the other could be computed at the time of user request.

Accordingly, the present invention provides for a method for reformulating these calculations between the categories of data based on an understanding of the problem domain and data model. It was observed that any calculations dependent upon user input data resulted in a large number of records being produced and stored, leading to poor performance similar to the previous approaches.

Accordingly, re-characterisation of the data and associated calculations were made by separating that part of the calculation which was dependent upon the input forecast data entered by users, and that part which was dependent upon the external assumptions (such as interest rate, device life times, and the like).

For example, if a formula Z was used to calculate the energy savings stream for a device such as a light bulb, where the formula Z is dependent upon user input data a, and external assumptions b. We could derive a new formula for Z as follows:

Z(a, b)=function(X(a), Y(b)) where X is dependent upon a, and Y is dependent upon b.

Calculating Y and storing the results allows for near real-time capabilities for computing Z based on those results. Updates to the outputs of Y based on changes to b could be done quickly, not necessarily in near real-time, but in minutes, although small changes could be updated in seconds. Processing X in conjunction with the retrieval and use of the results of Y would result in near real-time response for the calculation of Z.

For example in the case of the light bulb above, if Z were a function of a) installed cost, b)ongoing cost, c)replacement rate, d)device life (manufacturers), e)device usage (load shape) and f) removal rate., then Y(b) would include the parameters d) and e) of device usage (load shape) and removal rate can be pre-calculated.

An example of how storing pre-calculated values can save time and effort during reporting is illustrated by considering the calculation of the life of a device such as a light bulb, which was described above. If A typical light bulb last for 900 hours. In order to answer the question how many months can we expect the light bulb to function? We can assume the light bulb is on %100 of the time, then we can approximate that as 900 hours/24 hours in a day/30 days in a month=1.25 months. Let's say we want to improve that by turning off the light and using dimmer switches. The table below shows a kitchen light bulb's usage during a standard week:

| Hour | Sun | Mon | Tue | Wed | Thu | Fri | Sat |
|---|---|---|---|---|---|---|---|
| 0 | %0 | %0 | %0 | %0 | %0 | %0 | %0 |
| 1 | %0 | %0 | %0 | %0 | %0 | %0 | %0 |
| 2 | %0 | %0 | %0 | %0 | %0 | %0 | %0 |
| 3 | %0 | %0 | %0 | %0 | %0 | %0 | %0 |
| 4 | %0 | %0 | %0 | %0 | %0 | %0 | %0 |
| 5 | %0 | %0 | %0 | %0 | %0 | %0 | %0 |
| 6 | %0 | %0 | %0 | %0 | %0 | %0 | %0 |
| 7 | %0 | %100 | %100 | %100 | %100 | %100 | %0 |
| 8 | %0 | %100 | %100 | %100 | %100 | %100 | %0 |
| 9 | %100 | %100 | %100 | %100 | %100 | %100 | %100 |
| 10 | %100 | %0 | %0 | %0 | %0 | %0 | %100 |
| 11 | %100 | %0 | %0 | %0 | %0 | %0 | %100 |
| 12 | %100 | %0 | %0 | %0 | %0 | %0 | %100 |
| 13 | %100 | %0 | %0 | %0 | %0 | %0 | %100 |
| 14 | %100 | %0 | %0 | %0 | %0 | %0 | %100 |
| 15 | %100 | %0 | %0 | %0 | %0 | %0 | %100 |
| 16 | %100 | %0 | %0 | %0 | %0 | %0 | %100 |
| 17 | %100 | %50 | %50 | %50 | %50 | %50 | %100 |
| 18 | %100 | %50 | %50 | %50 | %50 | %50 | %100 |
| 19 | %100 | %50 | %50 | %50 | %50 | %50 | %100 |
| 20 | %100 | %50 | %50 | %50 | %50 | %50 | %100 |
| 21 | %0 | %0 | %0 | %0 | %0 | %0 | %0 |
| 22 | %0 | %0 | %0 | %0 | %0 | %0 | %0 |
| 23 | %0 | %0 | %0 | %0 | %0 | %0 | %0 |

The load shape (power usage based on actual usage over a period of time) is determined by assuming the kitchen light bulb is on primarily on the weekends, and in the mornings and evenings during the week. By adding up each percentage and dividing by the number of periods (24 hours a day*7 days a week=168), we get an average percent used of: %29.17. This means that the light bulb will actually live for 900/0.2917 or 3085 hours. That works out to about a life of 4.28 months. We store the calculated value of 4.28 in the database as a multiplier 152, so that anytime a report needs that value it does not need to calculate it.

These pre-calculated values (or multipliers) can be stored as a collection of tables 152. This allows us to retrieve them quickly after they are calculated, as apposed to having to recalculate them every time they are needed. Calculating device life, fuel delivery costs, and other values takes time. Without the multipliers, the system would need to calculate all these values every time the user ran a report. This would easily double or triple the time it takes to run a report.

Every time the user adds or modifies a device, customer class, region, resource or time period the multipliers that relate to that entity need to be re-calculated. When a change is made, a row is added to a multiplier changes table. Before any report which uses the multipliers is run, the report first checks to make sure the changes table is empty. If it is not empty, a message pops up informing the user that the multipliers need to be recalculated, and the required multipliers are updated. When an update occurs, only the required multipliers are updated. If the user makes a small, specific change (changing the device usage by a specific customer class) only the multipliers which relate to both that device and that customer class are changed. This recalculation will take a short period of time.

If the user makes a larger change, like a changing a resources time period load shape, than all the multipliers which relate to that resource will need to be recalculated. This recalculation will take a much longer period of time.

This is implemented such that when the application starts up, all the multipliers in the system are loaded into application memory. The report logic is free to use the multipliers from memory to speed up calculations.

For example: If a report needs to know average actual life of the light bulb, they first need to find the life of the bulb, then find out how many hours in a week that bulb is used. The multipliers already have that information multiplied out so the report does not need to do that; it can simply use the pre-calculated value.

Packages may also use multipliers, for example when calculating device load shapes. Most physical devices are active only part time. We allow the user to enter this data with 2 degrees of granularity: Hourly and Monthly. The user can say that a light bulb is active for half the day on Sundays, or they can say it is active for 30 hours in November. Each option is by customer class. For the monthly load shapes, there is other information like the peak coincident factor and the device savings persistence factor which are used in the calculations as mentioned earlier.

The reporter provides a number of DSM specific reports, called cost-effectiveness reports. These include:

Energy & Capacity Savings Report

Reports the energy and/or capacity, for selected DSM Programs, that are forecasted to be saved by the company, by implementing those DSM Programs.

GHG Report

This report calculates the units of GHGs (green house gases, either saved or additional) which are associated with the Expenditures. The Expenditures contain units of commodities. Commodities are associated with GHGs they produce.

Costs and Lost Revenues Report

Reports the dollar costs over a period of time for selected DSM Programs. The programs costs are forecasted in the expenditures that are included in DSM programs.

Benefits Report

Reports the dollar benefits over a period of time for the selected DSM Programs. The programs costs are forecasted in the expenditures that are included in DSM programs.

Utility Cost Roll-Ups Report

This report allow users to display costs, over the entire reporting period, rolled-up by Expenditure/DSM Program/Sector/Portfolio and by either Organization, or by Resource Code, or by a custom mix/combination of both Resource Codes and Organizations.

Cost Effectiveness Report

Reports various effectiveness indicators (such as Net Present Value, Benefit/Cost Ratio, Levelized Cost, IRR) for various effectiveness tests (such as Utility Test, All Ratepayers Test, Non-Participant Test, Participant Test) for selected DSM Programs.

Critical Values Report

The report is an analytical report designed to provide insight around thresholds and robustness of DSM Plans, Programs and sub-components. This report tells the user how much a specified variable can change by, in both present value and % terms, in order to yield either a TRC or RIM benefit/cost ratio target which can be specified by the user. The report returns values in total, and not individually, for all Expenditures chosen for the report.

Rate Impact Report

Reports the effect on energy rates, for selected DSM Programs. The output type of the report can be in % and $/KWh.

Participants Report

This report calculates the number of participants in DSM Programs per time interval.

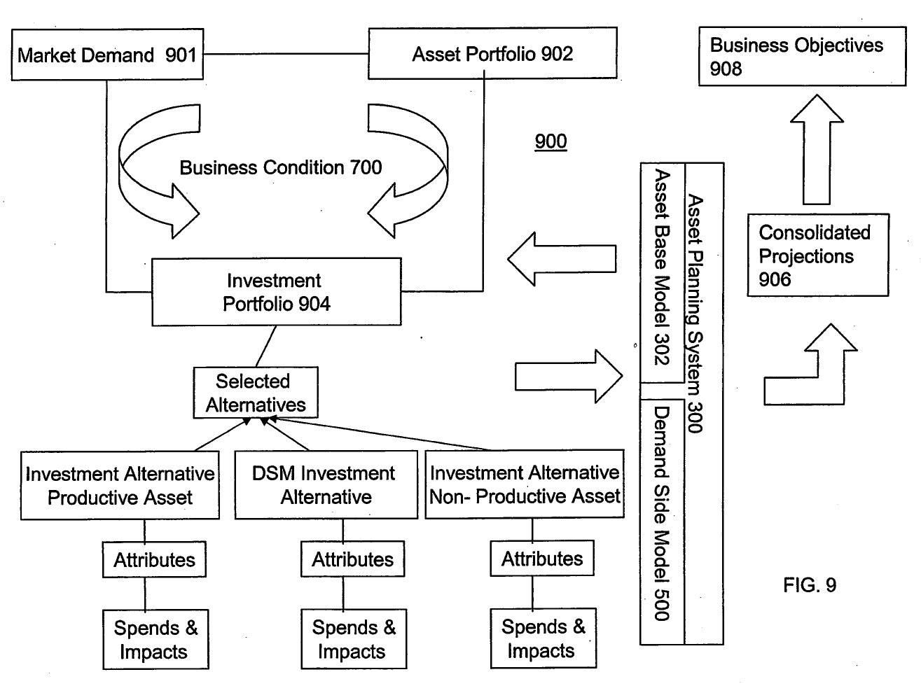

Referring now to FIG. 9, there is shown how the planning system of the present invention may be used for comparing investments in productive assets with investments in modifying demand for output of the productive assets, in an asset based business. The user may preferably provide through input into the system objectives or constraints of the business, although this is not essential. The reporter is then used to retrieve data from one or more asset data structures which as mentioned earlier store data representing assets of the business. Specifically, the type of assets stored are assets having an ascertainable productive output with forecastable market value. Each asset has an associated attribute data structure which stores one or more attribute value corresponding to the financial and non-financial productive outputs, inputs, and associated impacts of an asset over a time period which relates to the useful productive life of the asset. Once this data is retrieved, the system processes the retrieved data to generate a current and projected productive output set for a current asset investment comprising aggregated impact and costs attributes over time of selected assets. Consumer data is also retrieved from a demand data structure representing projected consumer demand. If a demand side management program is planned, then the consumer demand retrieved is for the modified consumer demand corresponding to the requested demand side management program. The system then processes the retrieved consumer data to generate a consolidated modified consumer demand comprising aggregated impact and costs attributes over time of the requested demand side management program and its effect on the projected and unmodified consumer demand. The system then displays all consolidated attributes of the asset investment, demand side management program, projected demand, current and projected productive output, and objectives and constraints of the business on the screen display so that the user may compare the various outputs to identifying conflicts between the current asset investment, the requested demand side management program, and the objectives or constraints of the business.

An organization can thus use the present invention to model the market and supply side of the their business and consider the impact of portfolios of investment, both in financial and non-financial terms, versus the objectives and constraints of the organization, and then optimize the investment portfolios against their objectives through either the insight of experienced users, or through the use of optimization algorithms as are known in the art and as have been described in copending U.S. application Ser. No. 11/967,672 filed Dec. 31, 2007, the disclosure of which is incorporated herein by reference in its entirety.

As described above, the embodiments of the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention.

An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The technical effect of the executable code is to facilitate prediction and optimization of model-based assets.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims.

We claim:

1. A method for reporting on asset investment alternatives in an asset based business, the method comprising steps of:
(a) retrieving data from one or more asset data structures each for storing data representing an asset of the business, the asset having an ascertainable productive output with forecastable market value and an attribute data structure associated with each asset data structure for storing one or more attribute values corresponding to the financial and non-financial productive outputs, inputs, and associated impacts of the asset over a time period which relates to the useful productive life of the asset; and
(b) generating a reported value, by applying to one or more said attribute values, a predetermined multiplier value, said reported value being a function of user input data, and external assumptions data.

2. The method as defined in claim 1, said predetermined multiplier value being pre-calculated by evaluating one or more of said attribute values to determine a sub set of said attribute values to be pre-calculated.

3. The method as defined in claim 2, said subset of attributes being determined by “report-type”.

4. The method as defined in claim 2, said subset of attributes being user selected.

5. A method for comparing investments in productive assets with investments in modifying demand for output of the productive assets, in an asset based business, the method comprising the steps of:
retrieving data from one or more asset data structures each for storing data representing assets of the business, the assets having an ascertainable productive output with forecastable market value and having an associated attribute data structure for storing one or more attribute value corresponding to the financial and non-financial productive outputs, inputs, and associated impacts of an asset over a time period which relates to the useful productive life of the asset;
processing said retrieved data to generate a current and projected productive output set for a current asset investment comprising aggregated impact and costs attributes over time of selected asset investments;
retrieving consumer data from a demand data structure representing modified consumer demand corresponding to a requested demand side management program;
processing said retrieved consumer data to generate a modified consumer demand comprising aggregated impact and costs attributes over time of the requested demand side management program;
displaying all consolidated attributes of the asset investment, demand side management program, projected demand, current and projected productive output for comparison.

6. The method as defined in claim 5, including inputting objectives or constraints of the business; and
displaying conflicts between the current asset investment, the requested demand side management program, and the objectives or constraints of the business.

7. A system for comparing investments in productive assets with investments in modifying demand for output of the productive assets, in an asset based business, the system comprising:
a computer implemented process for:
retrieving data from one or more asset data structures each for storing data representing assets of the business, the assets having an ascertainable productive output with forecastable market value and having an associated attribute data structure for storing one or more attribute value corresponding to the financial and non-financial productive outputs, inputs, and associated impacts of an asset over a time period which relates to the useful productive life of the asset;
processing said retrieved data to generate a current and projected productive output set for a current asset investment comprising aggregated impact and costs attributes over time of selected asset investments;
retrieving consumer data from a demand data structure representing modified consumer demand corresponding to a requested demand side management program;
processing said retrieved consumer data to generate a modified consumer demand comprising aggregated impact and costs attributes over time of the requested demand side management program;
displaying all consolidated attributes of the asset investment, demand side management program, projected demand, current and projected productive output for comparison.

8. The system as defined in claim 7, said computer implemented process including inputting objectives or constraints of the business.

9. The system as defined in claim 8, including displaying conflicts between the current asset investment, the requested demand side management program, and the objectives or constraints of the business.

10. A system for modeling demand for output supply of productive assets, in an asset based business, the system comprising:
a database having one or more demand data structures each comprising:
i. device field for storing data representing an identity of a device which consumes said output supply; and
ii. a data structure associated with each device for storing one or more attribute values corresponding to cost and benefits of the device over a time period.

11. The system as defined in claim 10, said devices including components or services.

12. The system as defined in claim 10, said demand data structure selectably organizable into a hierarchy of devices.

13. The system as defined in claim 10, including a package data structure for storing said one or more attribute values for one or more devices projected in relative time and being associable with said demand data structure in absolute time.
